(19) United States
(12) Patent Application Publication
(10) Pub. No.: US 2012/0060641 A1
(43) Pub. Date: Mar. 15, 2012

(54) BICYCLE PEDAL

(75) Inventor: Franc Arnold, Koblenz (DE)

(73) Assignee: RTI SPORTS/VERTRIEB VON SPORTARTIKELN GMBH, Urmitz (DE)

(21) Appl. No.: 13/050,000

(22) Filed: Mar. 17, 2011

(30) Foreign Application Priority Data
Mar. 18, 2010 (DE) 20 2010 003 825.1

(51) Int. Cl. B62M 3/08

(52) U.S. Cl. 74/560

(57) ABSTRACT

A bicycle pedal comprises a pedal body (10) with a foot support surface (12), a pedal axle (16) holding the pedal body (10) for rotation thereon, a bearing element arranged between the pedal axle (16) and the pedal body (10), a fixing element (20) preferably fully surrounding the pedal axle (16), with the fixing element (20) being provided for fixing the bearing element in the pedal body (10), and a guide element (22) arranged on an inner side of the pedal for lateral guidance of a foot (38) supported on the foot support surface (12), the guide element (22) at least partially covering the fixing element (20) when seen in plan view.

### CROSS-REFERENCE TO RELATED APPLICATIONS

The present invention claims the priority of German Utility Model Application DE 20 2010 003 825.1 filed Mar. 18, 2010, the disclosure of which is incorporated herein by reference.

### BACKGROUND OF THE INVENTION

1. Field of the Invention

The present invention relates to a bicycle pedal.

2. Description of the Prior Art

For guaranteeing a good and uniform force transmission onto the bicycle pedal, the position of the foot relative to the pedal, particularly relative to the pedal axle, has to be well-defined. In known bicycle pedals of the type used primarily in sports bicycles, this requirement is realized by so-called click pedals. In such pedals, the shoe sole is provided with a locking element cooperating with a locking element provided on the pedal body. This pedal system has the disadvantage that special shoes have to be used. Further, due to the protruding locking element on the sole of the shoe, such shoes are unfit for walking. As a further disadvantage of click pedals, these will subject unpracticed users to the risk of not being able to detach their foot from the pedal quickly enough. Particularly when the cyclist has to stop the bicycle or gets involved in a hazardous situation, this inability of detaching the foot from the pedal may lead to falls. Thus, click pedals have had a marketing breakthrough only on the sports sector. For use in city bikes, trekking bikes and the like, click pedals are unsuited.

Conventional pedals have the disadvantage that the position of the foot on the pedal is not well-defined. As a consequence, the force transmission is affected. Particularly, such faulty positions of the foot may expose the cyclist's joints to considerable stresses. Further, for fear that the foot might collide with the pedal crank during pedaling, cyclists often tend to set their foot onto the pedal relatively far towards the outer edge. However, in order to improve the stresses acting on the joints, particularly the stresses acting on the knee joint, it would be preferable to place the foot further inward near the pedal crank.

Further, the foot is often placed on the pedal too far forward in the longitudinal direction of the pedal, i.e. in the riding direction. This has the consequence that the force transmission does not take place in the area of the ball of the foot or the joint of the big toe, although the force transmission would be most effective in this area.

It is an object of the invention to provide a bicycle pedal wherein the position of the foot relative to the pedal is improved also without a tight connection between the shoe and the pedal.

### SUMMARY OF THE INVENTION

The bicycle pedal of the invention is configured in such a manner that no tight connection is established between a shoe sole and the pedal. Particularly, no locking elements or the like, as existent in kick pedals, are provided. The bicycle pedal comprises a pedal body, which preferably is made of plastic. The pedal body forms a foot support surface for the shoe. In the usual manner, the pedal body comprises two foot support surfaces facing away from each other, so that the foot can be rested on the pedal irrespective of the position of the latter. The pedal body is held for rotation about a pedal axle. The pedal axle carries a bearing element which, in the usual manner, comprises two rolling bearings. The free projection of the pedal axle is provided, in the usual manner, with a thread, thus allowing the pedal axle to be screwed into a threaded bore of the pedal crank. Between said thread and the pedal body, a fixing element is provided. For the configuration of the bearing element, this fixing element is required for biasing the bearing element. For this purpose, a commercially available pedal axle is inserted from the outside of the pedal and held by the fixing element. Further, pedal axes are known which are arranged in a sleeve. In this case, a sleeve, surrounding the pedal axle, is provided in the area of the bearing element, wherein said rolling bearings are arranged between the sleeve and the pedal axle. With the aid of said fixing element, the bearing element provided with a sleeve will be inserted, together with the pedal axle, into the pedal from the side of the pedal facing in the direction of the pedal crank, and particularly be screwed into the pedal.

According to the invention, the bicycle pedal comprises a guide element on an inner side of the pedal, i.e. on that side which is facing toward the pedal crank. By such a guide element, which particularly is formed as a web, there is realized a lateral guidance of the foot resting on the foot support surface. According to the invention, the guide element is configured and respectively arranged in such a manner that, when seen in plan view, it will at least partially cover said fixing element. Thereby, it is possible to shift the shoe very far inward in the direction of the pedal crank. The distance of the foot toward the pedal crank, which in commercially available pedal axes is absolutely required due to the fixing element, is thus reduced. This has the effect of allowing the foot to be placed closer to the pedal crank. As a result, there is achieved a better force transmission and an improvement of the Q factor. Due to the provision of an inner guide element, no danger exists anymore that the foot might be placed too far inward and a collision with the pedal crank might occur. By the provision of an inner guide element according to the invention, the lateral position of the foot will be defined. Particularly, the inventive design of the guide element makes it possible to arrange the foot close to the pedal crank because the guide element at least partially covers the fixing element. Thus, the user can shift his/her feet inward until the shoe is in abutment on the guide element. According to a particularly preferred embodiment, the guide element is configured such that a very small distance of preferably only 1 to 2 mm exists between the outer side of the guide element facing toward the pedal crank, and the pedal crank.

According to a further embodiment of the invention, an abutment face formed by the guide element, provided for lateral abutment of the shoe and thus facing towards the foot support surface, is at least partially of a concave shape. Particularly, the guide element is preferably concave in the front region, i.e. the region facing toward the riding direction, or is curved in the direction toward the foot support surface. Due to this concave design of the abutment face, the position of the foot is better defined also in the longitudinal direction of the pedal, i.e. in the riding direction. The curvature allows the shoe to be shifted forward in the riding direction while, in the inner area, the shoe is being shifted toward the pedal crank. The inner side of the shoe in the region of the big toe will then be in abutment on the curved region. By a guide element designed in the above manner, it is made possible, according to the invention, to place the foot on the bicycle pedal in a defined position without the necessity of a fixed connection of the shoe to the bicycle pedal, e.g. via a click-on system.

Instead of, or in addition to, a curvature of the abutment face in the region of a forward side of the pedal, it is also possible to provide a separate retaining element in this region so that there is provided, on the one hand, a guide element for realizing an inner guidance and/or, on the other hand, a retaining element for defining the position of the foot in the longitudinal direction of the pedal. In the above described embodiment, the retaining element is preferably formed in one piece with the guide element or, put differently, the guide element comprises a region serving as a retaining element. According to the invention, it is thus rendered possible, e.g. in city bikes which are often rode by bikers wearing street shoes, to realize an ergonomically good position of the foot.

The provision of a retaining element in the front region of the foot support surface of a pedal is a separate invention which is independent of the provision of a guide element on the inner side of the pedal. According to a preferred embodiment, however, these two inventions are combined with each other, wherein, with particular preference, the guide element is formed integrally with the retaining element.

According to a preferred embodiment of the invention, the guide element is not symmetrically formed when seen in a lateral view of the pedal. Instead, the guide element extends from a forward side of the pedal via the fixing element into a region between the pedal axle and a rear side of the pedal. Particularly, the guide element is connected to the pedal body between the pedal axle and the rear side of the pedal and thus does not extend all the way to the rear side of the pedal. Preferably, the guide element is connected to the rear area of the pedal body at a distance of 10 mm to 15 mm to the pedal axle.

It is, however, preferred that the pedal comprises a foot support surface on both horizontal sides and, correspondingly, two guide elements and/or two retaining elements are provided. The pedal thus does not have a special top side and a special bottom side since both side sides are identically designed. Therefore, the user does not have to consider on which side to place his/her foot. In this preferred embodiment, the pedal, when seen in lateral view, is point-symmetric to the rotary axis and respectively the pedal axle.

According to a further preferred embodiment, the guide element, in the region located behind the pedal axle when viewed in the pedal longitudinal direction or riding direction, is first arranged in such a manner that, starting from the pedal body, the guide element extends substantially horizontally and respectively towards the side in the direction toward the pedal crank. In this region, an upper side of the guide element does not project upward relative to the foot support surface. In its further course, the guide element is drawn upward and, according to a preferred embodiment, partially encloses the fixing element, particularly in the area of a quarter-circle. By the horizontal arrangement of the guide element, it is safeguarded that the shoe can be shifted completely toward the inside and thus can be moved to a position very close to the pedal crank.

Preferably, in the region of the pedal axle, the guide element has a height of 10 mm to 15 mm relative to the pedal axle. Relative to the foot support surface, the height of the guide element in the region of the pedal axle is at least 3 mm.

The guide element, which in lateral view preferably has a curved shape, comprises a lateral opening in the region of the fixing element. Thereby, it is guaranteed that the fixing element continues to be conveniently accessible. Depending on the given circumstances, it would be possible to develop pedal axles wherein an accessible fixing element is not required. This, however, would have the considerable disadvantage of a massive increase of costs. Thus, it is preferred to use a standard pedal axle as available on the market. In case of using newly developed pedal axles wherein a projecting fixing element of the mentioned type is not required, the guide element could be designed in such a manner that, when seen in plan view, it does not have to be arranged laterally of the foot support surface or has to be arranged only slightly laterally of the foot support surface. In this embodiment, such a necessity does not exist because the pedal does not comprise a lateral fixing element for the pedal axle and thus is allowed to be mounted close to the crankshaft. Nonetheless, also this embodiment is preferably provided with a retaining element which, according to a particularly preferred embodiment, is formed in one piece together with the guide element. In this arrangement, the guide element is different merely in that it does not laterally project as described in the context of the first preferred embodiment of the invention. Particularly, it is preferred that the concave curvature of the guide element and/or of the retaining element is provided also here.

Preferably, the guide element of the invention is arranged on both sides of the pedal, i.e. on the upper and lower sides, provided that the pedal is of the type with two opposite foot support surfaces. Herein, according to a preferred embodiment, the guide element is arranged substantially point-symmetrically relative to the pedal axle when seen in lateral view.

According to a particularly preferred embodiment of the invention which is an invention in its own right, the foot support surface or, in the given case, the two foot support surfaces is/are concave. This has the effect that the foot will slide in the direction of the pedal axle so that a further positional definition is achieved, while it is particularly preferred that said concave shape is provided in combination with the above described fixing element.

A further embodiment of the invention resides in that the pedal body has a wedge-shaped cross section, wherein the wedge is tapered toward the outside, i.e. away from the pedal crank. By such a varus wedge, an improvement of the foot position can be achieved. Particularly the combination of a curved foot support surface and a wedge-shaped cross section is an invention in its own right. Thereby, also without the provision of the above described guide element, an improvement of the foot position can be accomplished. Also in this arrangement, however, a combination with the above described guide element is preferred.

A full and enabling disclosure of the present invention, including the best mode thereof, enabling one of ordinary skill in the art to carry out the invention, is set forth in greater detail in the following description, including reference to the accompanying drawing in which

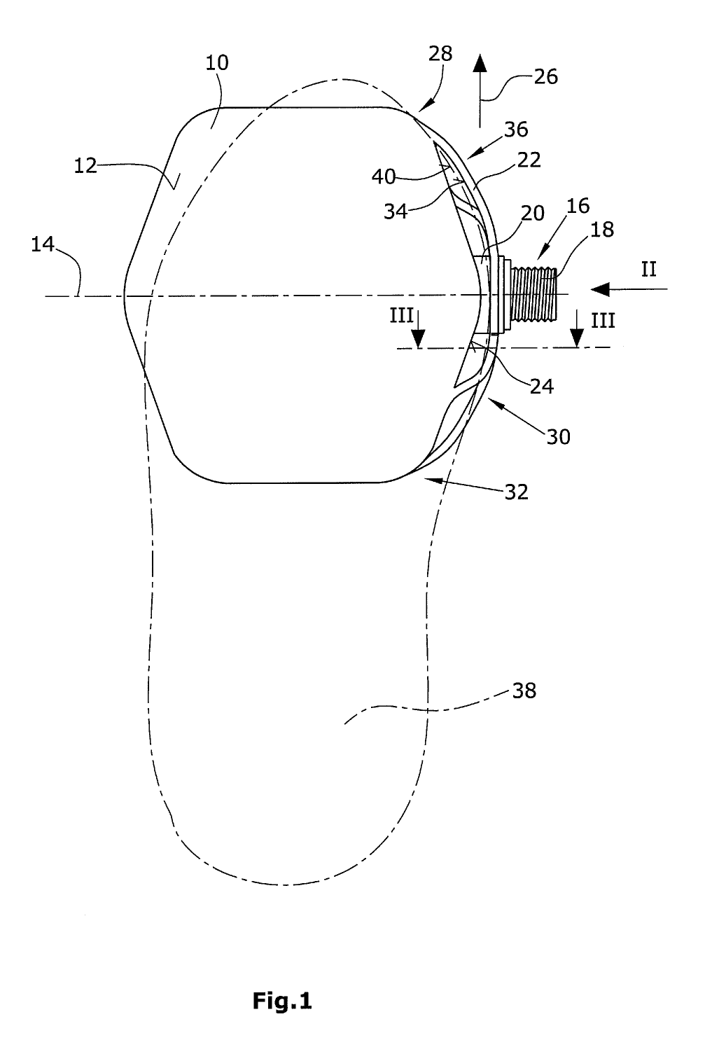

FIG. 1 is a schematic plan view of an embodiment of a bicycle pedal of the invention;

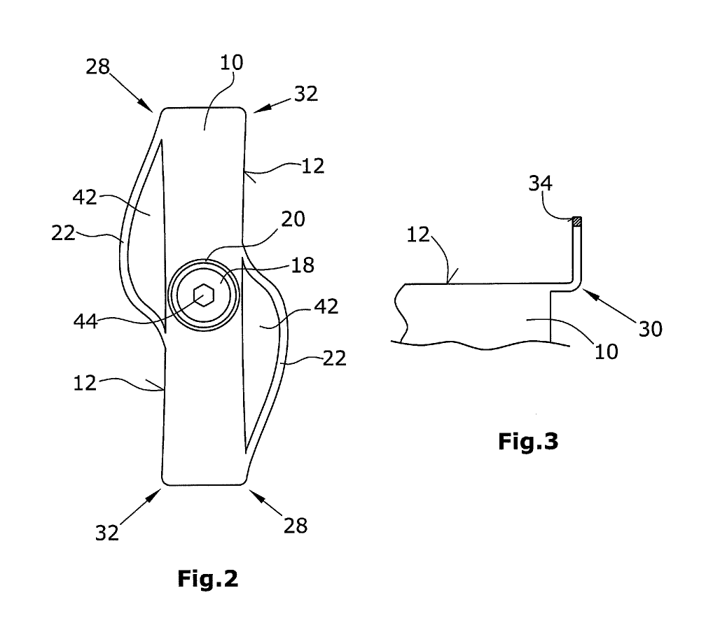

FIG. 2 is a schematic lateral view of the bicycle pedal as seen in the direction marked by arrow II in FIG. 1; and

FIG. 3 is a schematic sectional partial view taken along the line marked by III-III in FIG. 1.

### DETAILED DESCRIPTION OF PREFERRED EMBODIMENTS

The bicycle pedal of the invention comprises a pedal body 10. The pedal body is made of one piece or several pieces and is produced e.g. of plastic. Pedal body 10, particularly if it is of a multi-part type, can be provided with a cage or spatial structure enclosing the individual parts of the pedal body. In the illustrated embodiment, pedal body 10 comprises two foot support surfaces 12 facing away from each other. Said foot support surfaces 12 serve for supporting the cyclist's foot or shoe sole.

The bicycle pedal is rotatable about a transverse axis 14. For this purpose, a pedal axle 16 is arranged in an opening of pedal body 10. The free end of pedal axle 16 is provided with a thread 18. With the aid of said thread 18, the pedal can be screwed into a threaded bore formed on a pedal crank. Pedal axle 16 extends into pedal body 10. For allowing the pedal body 10 to be rotated about pedal axle 16, a bearing element is provided which usually comprises two ball bearings arranged within pedal body 10. In commercially available pedal axles, the ball bearings are fixed and optionally biased by a fixing element 20. Generally, there are used two differently designed types of pedal axles. In the first type, the pedal axle 16 is fixed from the outside, i.e. from the left side in FIG. 1. For this purpose, a bolt for holding the pedal axle and the bearings will be inserted from the left side. Said bolt is connected to fixing element 20 and adjusts the rolling bearings of the bearing elements. In a further commonly used design of pedal axles, the two rolling bearings are arranged within a sleeve. Said sleeve is held by the fixing element 20 and, as seen in FIG. 1, will be inserted from the right-hand side into a blind bore of pedal body 10.

According to the invention, the pedal body 10 is preferably integrally connected to a guide element 22. In the illustrated embodiment, guide element 22 is formed as a curved web. Said curved web 22 is arranged on an inner side 24 of the pedal which is facing toward the thread 18. Guide element 22 does not extend along the entire length of pedal body 10 but starts, in the longitudinal direction 26 or driving direction 26, in the region of a front side 28 of the pedal. From there, guide element 22 extends in the direction of fixing element 20 which, in plan view (FIG. 1), covers guide element 22. Then, in the rear region 30 of pedal body 10 relative to said transverse axis 14 or the pedal axle 16, guide element 22 is again connected to pedal body 10. Particularly, the connection between guide element 22 and pedal body 10 is provided in the rear region of the latter about halfway between the transverse axis 14 and a rear portion 32 of the pedal.

On its inner side, guide element 22 forms an abutment face 34. Said abutment face 34 has a concave shape in the direction of foot support surface 12. A forward region of guide element 22, when viewed in the moving direction, forms a retaining element 36. Said retaining element 36 is curved inward, i.e. in the direction of foot support surface 12, which is to say to the left in FIG. 1. Relative to the longitudinal direction 26 of the pedal, the retaining element 36 is arranged at an angle different from 0°, particularly an angle of 25° to 60°. By the retaining element 36, the position of the shoe on the foot support surface 12 is better defined because the shoe 36 will less easily slide in the longitudinal direction 26. Thereby, it is safeguarded that the force will be transmitted from the foot, via the ball of the foot and respectively the big-toe joint, onto the foot support surface 12 and respectively the pedal axle 16. An undesired sliding movement of the shoe 38 forward in the longitudinal direction 26 is prevented particularly if an inner side 40 of shoe 38 is in abutment on said abutment face 34 of guide element 22. This is effected in that the user will shift the shoe 38 inward in the direction of thread 18 and respectively the direction of the pedal crank.

By the inventive design of guide element 22, particularly in connection with the integrated retaining element 36, the shoe 38 can be placed on the pedal in a simple manner, as illustrated in FIG. 1. At any time, the user can improve the position of shoe 38 and thus the force transmission simply by pulling the shoe 38 inward. Further, the above arrangement guarantees an ergonomic position of the shoe, the foot and the legs.

An optimum position of shoe 38 can further be achieved in that said foot support surfaces 12 (FIG. 2) have a slightly concave shape. An additional ergonomic improvement can be obtained by giving the pedal body 10 a wedge-like shape, wherein said wedge tapers on the free side, i.e. toward the left side in FIG. 1. Thus, pedal body 10 is thicker near the thread 18 than on the left-hand outer end in FIG. 1.

When seen in lateral view (FIG. 2), guide element 22 comprises an opening 42. Said opening 42 is particularly provided in the region of fixing element 20 so that the fixing element 20 will remain easily accessible from outside. This is required for fixation of pedal axle 16 and respectively of the bearing elements within pedal body 10.

As further shown in said lateral view (FIG. 2), the pedal is point-symmetric to said transverse axis 14 which in FIG. 2 extends vertically to the plane of the drawing. In other words, this means that, in lateral view, the pedal is arranged in a point-symmetric position relative to a hexagonal opening 44 provided in axle 16. The hexagonal opening 44 serves for releasing the pedal axle 16 from said threaded bore of the pedal crank, and for screwing the pedal axle 16 into the threaded bore.

When seen in plan view, the guide element 22 extends, starting from pedal body 10 (FIG. 3), first horizontally and, respectively, substantially in the plane of foot support surface 12. Here, this region extends toward the outside and respectively horizontally so far that the outer edge 40 of shoe 38 can be arranged above this portion of guide element 22. Thereby, it is safeguarded that the displacement of shoe 38 inward in the direction of thread 18 will not be delimited too early but in fact will be delimited substantially only by that portion of guide element 22 which is arranged at the height of fixing element 20.

The above embodiment is a particularly preferred embodiment of the invention wherein both a guide element 22 and a retaining element 36 are provided. However, according to the invention, it is also possible to design pedals to the effect that either a guide element 22 or a retaining element 36 is provided. Still, according to a particularly preferred embodiment, both of said elements 22 and 36 are provided and particularly are formed in one piece as described above.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. A bicycle pedal comprising
a pedal body comprising a foot support surface,
a pedal axle holding the pedal body for rotation thereon,
a bearing element arranged between the pedal axle and the pedal body,
a fixing element preferably fully surrounding the pedal axle, said fixing element being provided for fixing the bearing element in the pedal body, and
a guide element arranged on an inner side of the pedal for lateral guidance of a foot supported on the foot support surface, the guide element at least partially covering the fixing element when seen in plan view.

2. The bicycle pedal according to claim 1, wherein, in the region of a front side of the pedal, the guide element comprises a retaining element for defining the position of the foot in the longitudinal direction.

3. A bicycle pedal comprising
a pedal body comprising a foot support surface,
a pedal axle holding the pedal body for rotation thereon,
a bearing element arranged between the pedal axle and the pedal body,
a retaining element, arranged in a front region of a foot support surface of the pedal, said retaining element being provided for defining the position of the foot in the longitudinal direction.

4. The bicycle pedal according to claim 3, wherein, on an inner side of the pedal, a guide element is provided for lateral guidance of a foot supported on the foot support surface, said guide element preferably merging into the retaining element.

5. The bicycle pedal according to claim 4, wherein a fixing element is provided, preferably fully surrounding the pedal axle, said fixing element being provided for fixing the bearing element in the pedal body, and a guide element, arranged on the inner side, is provided for lateral guidance of a foot supported on the foot support surface, said guide element at least partially covering the fixing element when seen in plan view.

6. The bicycle pedal according to claim 1, wherein the guide element and/or the retaining element comprise an abutment face facing in the direction of the foot support surface, said abutment face being at least partially concave.

7. The bicycle pedal according to claim 6, wherein the retaining element comprises a retaining surface merging into said abutment face particularly in a stepless manner.

8. The bicycle pedal according to claim 6, wherein the retaining element, particularly said retaining surface, is arranged at an angle different from 0° relative to the longitudinal direction of the pedal, and the retaining surface preferably is arranged to face in the direction of the pedal body.

9. The bicycle pedal according to claim 1, wherein the guide element, particularly together with the retaining element, extends from the front side of the pedal via the fixing element into a region between the pedal axle and a rear side of the pedal.

10. The bicycle pedal according to claim 1, wherein the guide element has a curved shape in lateral view.

11. The bicycle pedal according to claim 1, wherein the guide element comprises a lateral opening in the region of the fixing element.

12. The bicycle pedal according to claim 1, wherein the foot support surface is concave.

13. The bicycle pedal according to claim 1, wherein the pedal body and the guide element and particularly the retaining element are formed in one piece, preferably from plastic.
